(19) United States
(12) Patent Application Publication
(10) Pub. No.: US 2015/0081504 A1
(43) Pub. Date: Mar. 19, 2015

(54) Detection of Abusive Behavior in Electronic Markets

(71) Applicant: Chicago Mercantile Exchange Inc., Chicago, IL (US)

(72) Inventors: Terrence Janas, Oak Park, IL (US); Jacques Doornebos, Riverside, IL (US); Bruce Dickman, Wheeling, IL (US)

(73) Assignee: Chicago Mercantile Exchange Inc., Chicago, IL (US)

(21) Appl. No.: 14/031,789

(22) Filed: Sep. 19, 2013

(51) Int. Cl. G06Q 40/04

(52) U.S. Cl. CPC G06Q 40/04
USPC 705/37

(57) ABSTRACT

A method for identifying potential abusive behavior in an electronic market includes: (a) determining whether an individual order book associated with a trader comprises an imbalance in relation to a financial instrument for which the trader submitted an order; (b) determining whether an imbalance identified in the individual order book changed after fulfillment of the order; and (c) identifying the order as potential abusive behavior if the individual order book comprises an imbalance that changed after fulfillment of the order. Systems for identifying potential abusive behavior in an electronic market are described.

### BACKGROUND

Financial instruments are tradeable assets that may be broadly classified into two groups: cash instruments (e.g., securities, loans, deposits, etc.) and derivatives. A derivative is a type of financial instrument that derives its value from the value of an underlying entity, such as a physical commodity (e.g., agricultural products, mined resources, etc.) or another financial instrument (e.g., stocks, bonds, currencies, interest rates, financial indices, etc.). Derivatives may be broadly classified into two groups: (1) exchange-traded derivatives (e.g., futures, options on futures, etc.), which are traded on a futures exchange (Exchange); and (2) over-the-counter (OTC) derivatives (e.g., forwards, swaps, etc.), which are bilateral contracts privately traded between two parties without supervision from an Exchange.

The Chicago Mercantile Exchange Inc. (CME) is one example of an Exchange, which provides a contract market where financial instruments, such as futures and options on futures, are traded. The term “futures” is used to designate all contracts for the purchase or sale of financial instruments or physical commodities for future delivery or cash settlement on a commodity futures exchange. A futures contract is a legally binding agreement to buy or sell a commodity at a specified price at a predetermined future time.

In contrast to a futures contract, an option is the right, but not the obligation, to sell or buy the underlying instrument (e.g., a futures contract) at a specified price within a specified time. The commodity to be delivered in fulfillment of the contract or, alternatively, the commodity for which the cash market price shall determine the final settlement price of the futures contract, is known as the contract's underlying reference or “underlier.” The terms and conditions of each futures contract are standardized as to the specification of the contract's underlying reference commodity, the quality of such commodity, quantity, delivery date, and means of contract settlement (e.g., cash settlement, physical sale and purchase of the underlying reference commodity, etc.).

High-frequency trading (HFT) refers to the use of sophisticated computer algorithms to rapidly trade financial instruments in an electronic market. Traders engaged in HFT typically move in and out of positions within seconds or mere fractions of a second. As a result of its algorithmic nature, the practice of HFT is susceptible to abuse. For example, an order submitted by an abusive trader may not constitute a bona fide order to trade but rather an attempt to manipulate the electronic market for financial gain.

Various types of abusive trading techniques have been employed in efforts to gain financial advantage through market manipulation, including but not limited to quote stuffing, layering, order book fade, momentum ignition, and the like, and combinations thereof. One such abusive practice—commonly referred to as “spoofing”—was outlawed in 2010 by the Dodd-Frank Wall Street Reform and Consumer Protection Act. The term “spoofing” (a.k.a. messaging practice abuse) may be used to describe a sham order placed by a market participant who does not have the intent to trade said order but rather who seeks to manipulate other market participants (e.g., via automated trading systems) into placing orders that the abusive trader can then use to obtain a favorable fill on a bona fide order.

From the point of view of an abusive trader engaged in spoofing, the sham order is intended to reside, ideally, at or near (e.g., within the top 5 to 10 levels) the top-of-the-book (i.e., the best price currently available), so that it signals to the market a high degree of interest in buying or selling a certain asset. In one version of spoofing, an abusive trader places a large order to buy, which the trader has no intention of filling, just to manipulate other automated trading systems in the market into placing additional orders that the abuser can then use to obtain a favorable fill on a smaller order to sell, which was the trader's intent from the outset. The large order to buy sends a spurious signal to the marketplace that a large amount of buy pressure exists (e.g., the market is about to rise), which in turn prompts other market participants to join this side of the market. However, as soon as the small order to sell is filled, the abusive trader immediately cancels the larger buy order and, in so doing, is able to sell at the offer and buy at the bid, thereby securing optimum pricing.

Heretofore, detection of abusive trading behavior, such as spoofing, has been extremely time-consuming and involved labor-intensive manual examination techniques (e.g., trial-and-error manual searching through millions of stored messages, manual cross-referencing of public market data against private order entry messaging, manual calculation of order book levels and other metadata fields per message, etc.). In some instances, abusive behavior may escape detection altogether until or unless investigators are alerted to the suspected abuse through, for example, a complaint lodged by a market participant who observed anomalous activity on a given day between certain times in connection with a particular contract. Once alerted, investigators may then begin the painstaking process of manually examining all the relevant messages received within the identified timeframe in an attempt to isolate and identify the abusive behavior.

### BRIEF DESCRIPTION OF THE DRAWINGS

FIG. 1 shows a block diagram of a representative system 100 for detecting spoofing behavior in an electronic market in accordance with the present teachings.

FIG. 2 shows a flow chart of a representative process 200 for detecting spoofing behavior in an electronic market in accordance with the present teachings.

FIG. 3 shows a representative general computer system 300 for use with a system in accordance with the present teachings.

### DETAILED DESCRIPTION

The current process of investigation and examination is slow and laborious, and considerable time may elapse between the occurrence of abusive behavior and its eventual detection. At present, no mechanism exists for real time detection of potential abusive behavior.

Methods and systems for identifying potential abusive behavior in an electronic market (e.g., electronic trading, electronic commerce, etc.)—particularly though not exclusively behavior that imparts a false sense of liquidity to the market—have been discovered and are described herein. Representative types of abusive behavior that may be detected in accordance with the present teachings include but are not limited to flickering (e.g., when a trader puts in an order and cancels it before anyone can act on it), flipping (e.g., when a trader plays both sides of a market, flickering one side and filling the other), layering (e.g., when a trader enters larger orders at multiple levels of an order book to show bias for one side of the market), latency periods (e.g., when a trader enters orders simultaneously across multiple session IDs only to determine through which gateway the fastest round turn time occurs), and the like and combinations thereof. As used hereinafter, the term “spoofing” is used generically to encompass all manner of abusive trading behavior associated with the submission of an order for the purpose of manipulating an electronic market, including but not limited to the techniques identified above.

In some embodiments, the disclosed methods and systems can be used by Market Regulation to identify and detect potential spoofing activity in violation of Exchange rules and/or regulatory guidelines. Moreover, in some embodiments, the methods and systems can also be used to trigger other market safety mechanisms (e.g., if spoofing activity is detected, the market for the particular product may be placed in a locked or suspended state and/or the offending market participant may be blocked from submitting orders).

In some embodiments, methods and systems for detecting potential spoofing activity by market participants may involve associating exchange-generated metadata (e.g., which the Exchange may then use to track and recreate the state of the order book at any time during a trading day) with each incoming order. In some embodiments, a system in accordance with the present teachings is configured to generate a set of metadata, which in turn are configured for attachment to each incoming order and for tracking in a database. A database in accordance with the present teachings is configured to represent the state of the order book at any given time, with particular focus being placed on the top of the book.

In some embodiments, a system in accordance with the present teachings is configured to calculate and track in substantially real time one or more of the following metrics: (a) book level for every new order, order modification, and/or order cancellation; (b) manner of order modification (e.g., change in price, change in quantity, direction of any changes, and/or magnitude of any changes); (c) how long an order rests on the order book before it is modified and/or cancelled; (d) how the book level changes between order modifications and/or order cancellations; and (e) percentage of book level (e.g., for locating orders that are inserted, modified, and/or cancelled within specific book levels of the order book on a dynamic ad-hoc basis). As used herein, the phrase “real time” describes an event that occurs, or is perceived to occur, within the expectations of a particular participating entity and/or with only an imperceptible lapse in time.

In some embodiments, a system in accordance with the present teachings can utilize the metadata associated with incoming orders to filter the order book in such a way that spoofing activity becomes more readily identifiable. Since the definition of spoofing may vary based on market and/or prevailing market conditions (e.g., orders of a certain size may be considered spoofing in certain inactive markets, whereas similarly-sized orders would not be considered spoofing in more active, liquid markets), high-frequency trades with a probable spoofing component may be quickly found through the real-time calculation, filtering, and data-mining of metrics (e.g., book level, magnitude of quantity changes, magnitude of price changes, order duration, and the like, and combinations thereof).

Throughout this description and in the appended claims, the following definitions are to be understood:

The phrase “coupled with” is defined to mean directly connected to or indirectly connected through one or more intermediate components. Such intermediate components may include both hardware and software based components.

As used in the pending claims and to hereby provide notice to the public, the phrases “at least one of <A>, <B>, . . . and <N>” or “at least one of <A>, <B>, . . . <N>, or combinations thereof” are defined in the broadest sense, superseding any other implied definitions herebefore or hereinafter unless expressly asserted to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

While some embodiments described herein may make reference to the CME, it is to be understood that the present teachings are in no way restricted to the CME or, for that matter, to any specific Exchange. On the contrary, the present teachings are applicable to any Exchange, including but not limited to ones that trade in equities and/or other securities.

It is to be understood that elements and features of the various representative embodiments described below may be combined in different ways to produce new embodiments that likewise fall within the scope of the present teachings.

By way of general introduction, a method for identifying potential abusive behavior in an electronic market in accordance with the present teachings comprises: (a) determining whether an individual order book associated with a trader comprises an imbalance in relation to a financial instrument for which the trader submitted an order; (b) determining whether an imbalance identified in the individual order book changed after fulfillment of the order; and (c) identifying the order as potential abusive behavior if the individual order book comprises an imbalance that changed after fulfillment of the order.

In some embodiments, a book imbalance represents how much larger (e.g., how many multiples larger) a resting quantity on one side of a market is over a resting quantity on the other side of the market within the top X book levels (e.g., assuming that both sides have a non-zero resting quantity). For example, in some embodiments, a trader does not have an imbalance if all of the trader's open orders that reside within the top X book levels are all on the same side of the book. In some embodiments, a trader likewise does not have an imbalance if the trader has no open orders within the top X book levels, or if the sum of the trader's resting order quantity of the top X bid-side book levels is equal to the sum of the trader's resting order quantity of the top X offer-side book levels. By way of example, in some embodiments, a trader has an imbalance ratio of 3 if the sum of the trader's resting buy orders within the top X book levels is 60, while the sum of the trader's resting sell orders within the top X book levels is 180.

For purposes of illustration, a representative and non-limiting example of an imbalance in relation to a financial instrument is as follows:
Top of book for ESU3 is 1652.75 bid for 500 contracts and 1653.00 offer for 450 contracts.
Entity enters buy order for 2000 contracts at 1652.75 creating a large buy imbalance: 2500 to buy, 450 to sell.
The offer is taken, which included an offer entered by the participant who entered the 2000 lot buy order who then cancels the buy order relieving the large imbalance.

The type of potential abusive behavior to be identified in accordance with the present teachings is not restricted. By way of example, in some embodiments, representative types of potential abusive behavior include but are not limited to spoofing, flipping, layering, flickering, latency periods, and the like, and combinations thereof.

In some embodiments, a method in accordance with the present teachings further comprises one or a plurality of the following additional acts: (d) receiving the order for the financial instrument from the trader; (e) receiving a counter order for the financial instrument from the trader, wherein the counter order lies on a side of a trade that is opposite to the order; (f) determining whether an imbalance identified in the trader's individual order book lies on a side of a trade that is opposite to that of the order; (g) attaching metadata to each incoming message received from the trader, wherein the trader is uniquely identifiable from the metadata; (h) recreating a state of the individual order book associated with the trader and/or a state of a full order book associated with the electronic market; (i) filtering the full order book and/or the individual order book based on metadata; and/or (j) tracking a metric selected from the group consisting of book level, order duration, magnitude of change in order quantity, magnitude of change in order price, and the like, and combinations thereof.

In some embodiments, a method for identifying potential abusive behavior in an electronic market in accordance with the present teachings is implemented using a computer and, in some embodiments, one or a plurality of the acts of (a) determining, (b) determining, (c) identifying, (d) receiving, (e) receiving, (f) determining, (g) attaching, (h) recreating, (i) filtering, and/or (j) tracking described above may be performed by one or a plurality of processors.

Implementing the methods for identifying potential abusive behavior in an electronic market in accordance with the present teachings by a computer may reduce overall resources. By way of example, since order-entry messages are already captured and recorded in real-time by existing systems, additional efficiency in terms of CPU and memory may be achieved if meta-data fields (e.g., including but not limited to book level, book imbalance, order duration, price/quantity difference, and/or the like) are computed in real-time as opposed to being calculated via a batch job since the program already knows the current working order book in real time from having processed messages and attached meta-data fields to the records. Without such a configuration, a computer would require significantly more CPU time and memory in order to determine what book level an order resided at for a particular moment in time since the computer would have to replay data from the beginning of the trading week to calculate the order book at that particular moment in time.

In some embodiments, functionality for identifying potential abusive behavior in an electronic market in accordance with the present teachings may be incorporated into a trading match engine of a type that is operated by an Exchange. In such embodiments, the trading engine may be configured to cut off a trader suspected of abusive behavior and/or institute certain prohibitions and/or limitations on trading when an abuse is suspected (e.g., prohibiting or limiting order cancellations and/or order modifications within a certain period of time, etc.).

The order being evaluated for potential abusive behavior in accordance with the present teachings includes all manner of order types that a trader may submit, including but not limited to bids (e.g., bids to buy), offers (e.g., offers to sell), and the like, and combinations thereof. In some embodiments, the order to be evaluated for potential abusive behavior in accordance with the present teachings appears as a top 10 entry, in some embodiments as a top 5 entry, and in some embodiments as a “top-of-the-book” entry in a full order book associated with the electronic market.

In some embodiments, the trader who submits the order to be evaluated for potential abusive behavior in accordance with the present teachings comprises an individual working independently and/or the technological tools (e.g., computer systems, etc.) used by the individual. In some embodiments, the trader who submits the order to be evaluated for potential abusive behavior in accordance with the present teachings comprises a firm and/or the technological tools (e.g., computer systems, etc.) used by the firm.

In some embodiments, the imbalance identified in a trader's individual order book in accordance with the present teachings comprises a buy order on one side of a trade and a sell order on an opposite side of the trade. In some embodiments, the buy order is larger than the sell order. In other embodiments, the buy order is smaller than the sell order.

The type of change in an imbalance identified in a trader's individual order book that is to be determined in accordance with the present teachings is not restricted. In some embodiments, representative types of change include but are not limited to a partial cancellation of a resting order (e.g., an order remaining on the full order book associated with the electronic market that has not yet been filled), a complete cancellation of a resting order, a modification (e.g., a change in price, a change in quantity, a change in both price and quantity, etc.) of a resting order that moves the resting order away from a top of the full order book, and the like, and combinations thereof.

In some embodiments, potential abusive behavior is identified retroactively based on historical trading data (e.g., incoming messages) stored in a database. In some embodiments, the potential abusive behavior is identified in real time based on substantially contemporaneous trading data. In some embodiments, the potential abusive behavior is identified using a combination of historical trading data stored in a database and substantially contemporaneous trading data.

In some embodiments, as described above, a method in accordance with the present teachings further comprises recreating a state of the individual order book associated with the trader and/or a state of a full order book associated with the electronic market. In some embodiments, the recreating is based on metadata attached to each incoming message received from the trader.

A method for recreating a state of an order book for a financial instrument in accordance with the present teachings comprises (i) attaching exchange-generated metadata to each incoming message received from a trader, wherein the metadata uniquely identifies the trader; (ii) tracking a metric selected from the group consisting of book level, order duration, magnitude of change in order quantity, magnitude of change in order price, and combinations thereof, wherein the tracking is based on the exchange-generated metadata and wherein the tracking occurs in real time using substantially contemporaneous data; and (iii) storing data relating to the tracked metric in a database.

The nature of the incoming message received from the trader is not restricted. Representative types of incoming messages include but are not limited to a new order for a financial instrument, a modification to an order for a financial instrument, a cancellation of an order for a financial instrument, and the like, and combinations thereof.

In some embodiments, a method for recreating a state of an order book for a financial instrument in accordance with the present teachings is implemented using a computer and, in some embodiments, one or a plurality of the acts of (i) attaching, (ii) tracking, and/or (iii) storing described above may be performed by one or a plurality of processors.

In some embodiments, as described above, the present teachings provide methods for identifying potential abusive behavior in an electronic market. In other embodiments, as further described below, the present teachings also provide systems for identifying potential abusive behavior in an electronic market.

By way of example, a first system for identifying potential abusive behavior in an electronic market in accordance with the present teachings comprises a processor coupled to a non-transitory memory, wherein the processor is operative to execute computer program instructions to cause the processor to: (a) determine whether an individual order book associated with a trader comprises an imbalance in relation to a financial instrument for which the trader submitted an order; (b) determine whether an imbalance identified in the individual order book changed after fulfillment of the order; and (c) identify the order as potential abusive behavior if the individual order book comprises an imbalance that changed after fulfillment of the order.

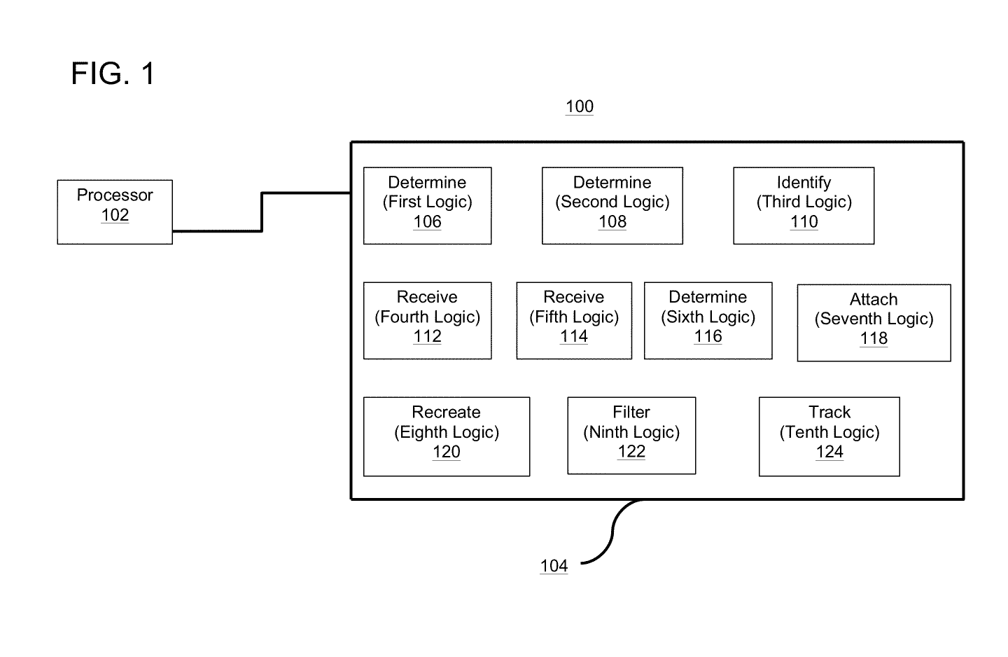

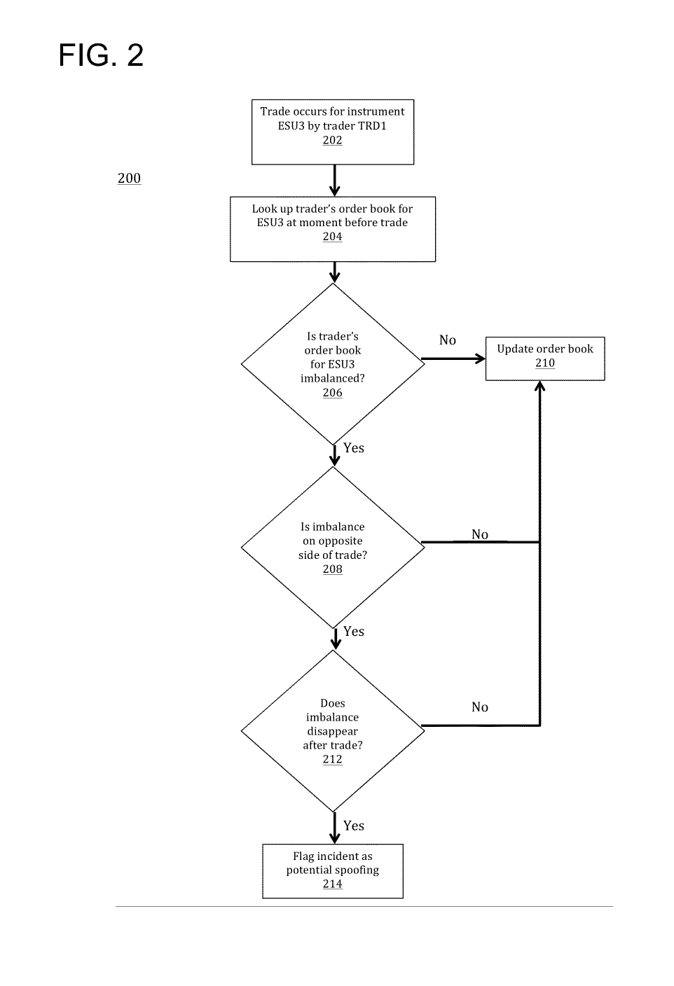

Further aspects of the present teachings will now be described in reference to the drawings. FIG. 1 shows a block diagram of a representative system 100 for identifying potential abusive behavior in an electronic market in accordance with the present teachings. FIG. 2 depicts a flow chart showing exemplary operation of the representative system 100 for identifying potential abusive behavior in an electronic market shown in FIG. 1.

In some embodiments, as shown in FIG. 1, a system 100 for identifying potential abusive behavior in an electronic market in accordance with the present teachings is implemented as part of an abusive behavior detection module in a computer system. As shown in FIG. 1, the system 100 comprises: a processor 102; a non-transitory memory 104 coupled with the processor 102; first logic 106 stored in the non-transitory memory 104 and executable by the processor 102 to cause the processor 102 to determine whether an individual order book associated with a trader comprises an imbalance in relation to a financial instrument for which the trader submitted an order; second logic 108 stored in the non-transitory memory 104 and executable by the processor 102 to cause the processor 102 to determine whether an imbalance identified in the individual order book has changed after fulfillment of the order; and third logic 110 stored in the non-transitory memory 104 and executable by the processor 102 to cause the processor 102 to identify the order as potential abusive behavior if the individual order book comprises an imbalance that changed after fulfillment of the order.

In some embodiments, the system 100 may be coupled to other modules of a computer system and/or to databases so as to have access to relevant information as needed (e.g., historical trading data, such as stored messages and/or the like, etc.) and initiate appropriate actions.

In some embodiments, as shown in FIG. 1, the system 100 further includes fourth logic 112 stored in the non-transitory memory 104 and executable by the processor 102 to cause the processor 102 to receive the order for the financial instrument from the trader. In some embodiments, the system 100 further includes fifth logic 114 stored in the non-transitory memory 104 and executable by the processor 102 to cause the processor 102 to receive a counter order for the financial instrument from the trader, wherein the counter order lies on a side of a trade that is opposite to the order. In some embodiments, the system 100 further includes sixth logic 116 stored in the non-transitory memory 104 and executable by the processor 102 to cause the processor 102 to determine whether an imbalance identified in the trader's individual order book lies on a side of a trade that is opposite to that of the order. In some embodiments, the system 100 further includes seventh logic 118 stored in the non-transitory memory 104 and executable by the processor 102 to cause the processor 102 to attach metadata to each incoming message received from the trader, wherein the trader is uniquely identifiable from the metadata. In some embodiments, the system 100 further includes eighth logic 120 stored in the non-transitory memory 104 and executable by the processor 102 to cause the processor 102 to recreate a state of the individual order book associated with the trader and/or a state of a full order book associated with the electronic market. In some embodiments, the system 100 further includes ninth logic 122 stored in the non-transitory memory 104 and executable by the processor 102 to cause the processor 102 to filter the full order book and/or the individual order book based on the metadata. In some embodiments, the system 100 further includes tenth logic 124 stored in the non-transitory memory 104 and executable by the processor 102 to cause the processor 102 to track a metric selected from the group consisting of book level, order duration, magnitude of change in order quantity, magnitude of change in order price, and the like, and combinations thereof. In some embodiments, the processor 102 is operative to perform only one, all, or a subset of the above-described functions.

FIG. 2 depicts a flow chart showing exemplary operation of the system 100 of FIG. 1. In particular, FIG. 2 shows a computer-implemented method 200 for identifying potential abusive behavior in an electronic market in accordance with the present teachings. At block 202, a trade occurs for an instrument ESU3 submitted by a trader TRD1. At block 204, the trader's individual order book for ESU3 at the moment before the trade is examined (e.g., by recreating the individual order book from stored metadata, as described above), and the sum of all resting orders on each side (e.g., bid and offer) of the trader's individual order book for instrument ESU3 is calculated. To recreate the trader's individual order book, all open orders apart from those entered by trader TRD1 for instrument ESU3 may be excluded from consideration.

At block 206, a determination is made as to whether the trader's individual order book for ESU3 is imbalanced. If the trader's order book is imbalanced, the process proceeds to block 208. If the trader's order book is not imbalanced, the process proceeds to block 210 where the order book is updated and the processing of messages may continue. At block 208, a determination is made as to whether the imbalance lies on the opposite side of the trade (e.g., is the sum of resting orders on the trade side less than the sum of resting orders on the opposite side). If the imbalance does not lie on the opposite side of the trade, the process proceeds to block 210. If the imbalance is on the opposite side of the trade, the process proceeds to block 212.

At block 212, a determination is made as to whether the imbalance disappears immediately after the trade (e.g., are resting orders on the imbalance side canceled or modified away from the top of the book). If the imbalance disappears immediately after the trade, the incident is flagged as potential spoofing behavior at block 214. If the imbalance does not disappear immediately after the trade, the process proceeds to block 210.

For purposes of illustration—and not to in any measure limit the scope of the appended claims or their equivalents—the following data illustrate one example of potential abusive behavior that may be identified in accordance with the present teachings:
1) At 2:05, TRADER_X has no open orders
2) From 2:05:27-2:05:39, TRADER_X enters sell orders totaling 8 contracts across the top 3 levels of the book
3) At 2:05:41.953, TRADER_X enters a buy order for 1 contract at the top of the book (new best bid)
4) At 2:05:41.956, that buy order is filled.
5) At 2:05:43.356 (2 seconds later), TRADER_X enters another buy order for 1 contract at the same price
6) At 2:05:43.357, that buy order is filled
7) At 2:05:44, TRADER_X cancels all the sell orders from 2)

For purposes of further illustration—and not to in any measure limit the scope of the appended claims or their equivalents—the data shown in Table 1 below illustrate an additional example of a type of spoofing that may be identified in accordance with the present teachings. As shown by the data in Table 1, an Account enters 4 to buy at 23735 and then enters 100 to sell at 23750, thereby creating perceived selling bias in the instrument. In less than a second after the smaller buy order trades, the large sell order is cancelled.

TABLE 1

| | | | | | Account | Tag | Func | Buy | | | |
|---|---|---|---|---|---|---|---|---|---|---|---|
| Date | Time | Group | Instrument | Firm (AT) | (AT) | 50 | Code | Sell | Quantity | Price (AT) | OrderID |
| 5/2/2013 | 06:26:06.345 | SI | SIN3 | xyz | 123 | me | 1 | B | 4 | 23735 | 456 |
| 5/2/2013 | 06:26:28.689 | SI | SIN3 | xyz | 123 | me | 1 | S | 100 | 23750 | 789 |
| 5/2/2013 | 06:26:28.694 | SI | SIN3 | xyz | 123 | me | 105 | B | 1 | 23735 | 456 |
| 5/2/2013 | 06:26:28.872 | SI | SIN3 | xyz | 123 | me | 105 | B | 1 | 23735 | 456 |
| 5/2/2013 | 06:26:28.874 | SI | SIN3 | xyz | 123 | me | 105 | B | 1 | 23735 | 456 |
| 5/2/2013 | 06:26:29.533 | SI | SIN3 | xyz | 123 | me | 3 | S | 100 | 23750 | 789 |

An additional example of potential abusive behavior that may be identified in accordance with the present teachings may be found on the internet at http://www.nanex.net/aqck2/4371/coscia-appendix-1a.pdf

It is to be understood that the relative ordering of some acts shown in the flow chart of FIG. 2 is meant to be merely representative rather than limiting, and that alternative sequences may be followed. Moreover, it is likewise to be understood that additional, different, or fewer acts may be provided, and that two or more of these acts may occur sequentially, substantially contemporaneously, and/or in alternative orders.

A third system for identifying potential abusive behavior in an electronic market comprises: means for determining whether an individual order book associated with a trader comprises an imbalance in relation to a financial instrument for which the trader submitted an order; means for determining whether an imbalance identified in the individual order book changed after fulfillment of the order; and means for identifying the order as potential abusive behavior if the individual order book comprises an imbalance that changed after fulfillment of the order.

A non-transitory computer-readable storage medium in accordance with the present teachings has stored therein data representing instructions executable by a programmed processor for identifying potential abusive behavior in an electronic market. The storage medium comprises instructions for: (a) determining, by a processor, whether an individual order book associated with a trader comprises an imbalance in relation to a financial instrument for which the trader submitted an order; (b) determining, by the processor, whether an imbalance identified in the individual order book changed after fulfillment of the order; and (c) identifying, by the processor, the order as potential abusive behavior if the individual order book comprises an imbalance that changed after fulfillment of the order.

One skilled in the art will appreciate that one or more modules or logic described herein may be implemented using, among other things, a tangible computer-readable medium comprising computer-executable instructions (e.g., executable software code). Alternatively, modules may be implemented as software code, firmware code, hardware, and/or a combination of the aforementioned. For example the modules may be embodied as part of an Exchange for financial instruments.

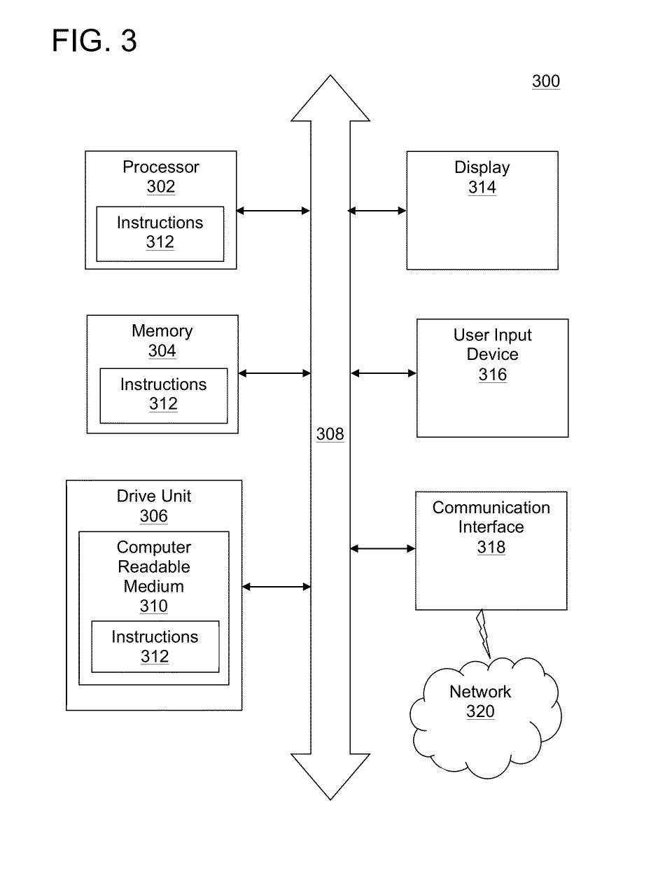

FIG. 3 depicts an illustrative embodiment of a general computer system 300. The computer system 300 can include a set of instructions that can be executed to cause the computer system 300 to perform any one or more of the methods or computer based functions disclosed herein. The computer system 300 may operate as a standalone device or may be connected (e.g., using a network) to other computer systems or peripheral devices. Any of the components discussed above, such as the processor, may be a computer system 300 or a component in the computer system 300. The computer system 300 may implement an order-grouping engine on behalf of an Exchange, such as the Chicago Mercantile Exchange, of which the disclosed embodiments are a component thereof.

In a networked deployment, the computer system 300 may operate in the capacity of a server or as a client user computer in a client-server user network environment, or as a peer computer system in a peer-to-peer (or distributed) network environment. The computer system 300 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In some embodiments, the computer system 300 can be implemented using electronic devices that provide voice, video or data communication. Further, while a single computer system 300 is illustrated, the term “system” shall also be taken to include any collection of systems or sub-systems that individually or jointly execute a set, or multiple sets, of instructions to perform one or more computer functions.

As shown in FIG. 3, the computer system 300 may include a processor 302, for example a central processing unit (CPU), a graphics-processing unit (GPU), or both. The processor 302 may be a component in a variety of systems. For example, the processor 302 may be part of a standard personal computer or a workstation. The processor 302 may be one or more general processors, digital signal processors, application specific integrated circuits, field programmable gate arrays, servers, networks, digital circuits, analog circuits, combinations thereof, or other now known or later developed devices for analyzing and processing data. The processor 302 may implement a software program, such as code generated manually (i.e., programmed).

The computer system 300 may include a memory 304 that can communicate via a bus 308. The memory 304 may be a main memory, a static memory, or a dynamic memory. The memory 304 may include, but is not limited to, computer-readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In some embodiments, the memory 304 includes a cache or random access memory for the processor 302. In alternative embodiments, the memory 304 is separate from the processor 302, such as a cache memory of a processor, the system memory, or other memory. The memory 304 may be an external storage device or database for storing data. Examples include a hard drive, compact disc (CD), digital video disc (DVD), memory card, memory stick, floppy disc, universal serial bus (USB) memory device, or any other device operative to store data. The memory 304 is operable to store instructions executable by the processor 302. The functions, acts or tasks illustrated in the figures or described herein may be performed by the programmed processor 302 executing the instructions 312 stored in the memory 304. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown in FIG. 3, the computer system 300 may further include a display unit 314, such as a liquid crystal display (LCD), an organic light emitting diode (OLED), a flat panel display, a solid state display, a cathode ray tube (CRT), a projector, a printer or other now known or later developed display device for outputting determined information. The display 314 may act as an interface for the user to see the functioning of the processor 302, or specifically as an interface with the software stored in the memory 304 or in the drive unit 306.

Additionally, as shown in FIG. 3, the computer system 300 may include an input device 316 configured to allow a user to interact with any of the components of system 300. The input device 316 may be a number pad, a keyboard, or a cursor control device, such as a mouse, or a joystick, touch screen display, remote control or any other device operative to interact with the system 300.

In some embodiments, as shown in FIG. 3, the computer system 300 may also include a disk or optical drive unit 306. The disk drive unit 306 may include a computer-readable medium 310 in which one or more sets of instructions 312 (e.g., software) can be embedded. Further, the instructions 312 may embody one or more of the methods or logic as described herein. In some embodiments, the instructions 312 may reside completely, or at least partially, within the memory 304 and/or within the processor 302 during execution by the computer system 300. The memory 304 and the processor 302 also may include computer-readable media as described above.

The present teachings contemplate a computer-readable medium that includes instructions 312 or receives and executes instructions 312 responsive to a propagated signal, so that a device connected to a network 320 can communicate voice, video, audio, images or any other data over the network 320. Further, the instructions 312 may be transmitted or received over the network 320 via a communication interface 318. The communication interface 318 may be a part of the processor 302 or may be a separate component. The communication interface 318 may be created in software or may be a physical connection in hardware. The communication interface 318 is configured to connect with a network 320, external media, the display 314, or any other components in system 300, or combinations thereof. The connection with the network 320 may be a physical connection, such as a wired Ethernet connection or may be established wirelessly as discussed below. Likewise, the additional connections with other components of the system 300 may be physical connections or may be established wirelessly.

The network 320 may include wired networks, wireless networks, or combinations thereof. The wireless network may be a cellular telephone network, an 802.11, 802.16, 802.20, or WiMax network. Further, the network 320 may be a public network, such as the Internet, a private network, such as an intranet, or combinations thereof, and may utilize a variety of networking protocols now available or later developed including, but not limited to TCP/IP based networking protocols.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of subject matter described in this specification can be implemented as one or more computer program products, for example, one or more modules of computer program instructions encoded on a computer-readable medium for execution by, or to control the operation of, data processing apparatus. While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein. The computer-readable medium can be a machine-readable storage device, a machine-readable storage substrate, a memory device, or a combination of one or more of them. The term “data processing apparatus” encompasses all apparatuses, devices, and machines for processing data, including but not limited to, by way of example, a programmable processor, a computer, or multiple processors or computers. The apparatus can include, in addition to hardware, code that creates an execution environment for the computer program in question (e.g., code that constitutes processor firmware, a protocol stack, a database management system, an operating system, or a combination thereof).

In some embodiments, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the present teachings are considered to include any one or more of a computer-readable medium or a distribution medium and other equivalents and successor media, in which data or instructions may be stored.

In some embodiments, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In some embodiments, the methods described herein may be implemented by software programs executable by a computer system. Further, in some embodiments, implementations can include distributed processing, component/object distributed processing, and parallel processing. Alternatively, virtual computer system processing can be constructed to implement one or more of the methods or functionality as described herein.

Although the present teachings describe components and functions that may be implemented in particular embodiments with reference to particular standards and protocols, the present invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform functions by operating on input data and generating output. The processes and logic flows can also be performed by, and apparatus can also be implemented as, special purpose logic circuitry, for example, an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The main elements of a computer are a processor for performing instructions and one or more memory devices for storing instructions and data. Generally, a computer will also include, or be operatively coupled to receive data from or transfer data to, or both, one or more mass storage devices for storing data, for example, magnetic, magneto optical disks, or optical disks. However, a computer need not have such devices. Moreover, a computer can be embedded in another device, for example, a mobile telephone, a personal digital assistant (PDA), a mobile audio player, a Global Positioning System (GPS) receiver, to name just a few. Computer-readable media suitable for storing computer program instructions and data include all forms of non volatile memory, media and memory devices, including but not limited to, by way of example, semiconductor memory devices (e.g., EPROM, EEPROM, and flash memory devices); magnetic disks (e.g., internal hard disks or removable disks); magneto optical disks; and CD ROM and DVD-ROM disks. The processor and the memory can be supplemented by, or incorporated in, special purpose logic circuitry.

To provide for interaction with a user, some embodiments of subject matter described herein can be implemented on a device having a display, for example a CRT (cathode ray tube) or LCD (liquid crystal display) monitor, for displaying information to the user and a keyboard and a pointing device, for example a mouse or a trackball, by which the user can provide input to the computer. Other kinds of devices can be used to provide for interaction with a user as well. By way of example, feedback provided to the user can be any form of sensory feedback (e.g., visual feedback, auditory feedback, or tactile feedback); and input from the user can be received in any form, including but not limited to acoustic, speech, or tactile input.

Embodiments of subject matter described herein can be implemented in a computing system that includes a back-end component, for example, as a data server, or that includes a middleware component, for example, an application server, or that includes a front end component, for example, a client computer having a graphical user interface or a Web browser through which a user can interact with an implementation of the subject matter described in this specification, or any combination of one or more such back end, middleware, or front end components. The components of the system can be interconnected by any form or medium of digital data communication, for example, a communication network. Examples of communication networks include but are not limited to a local area network (LAN) and a wide area network (WAN), for example, the Internet.

The computing system can include clients and servers. A client and server are generally remote from each other and typically interact through a communication network. The relationship of client and server arises by virtue of computer programs running on the respective computers and having a client-server relationship to each other.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 CFR §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims can, alternatively, be made to depend in the alternative from any preceding claim—whether independent or dependent—and that such new combinations are to be understood as forming a part of the present specification.

The foregoing detailed description and the accompanying drawings have been provided by way of explanation and illustration, and are not intended to limit the scope of the appended claims. Many variations in the presently preferred embodiments illustrated herein will be apparent to one of ordinary skill in the art, and remain within the scope of the appended claims and their equivalents.

1. A computer-implemented method for identifying potential abusive behavior in an electronic market, the method comprising:
determining, by a processor, whether an individual order book associated with a trader comprises an imbalance in relation to a financial instrument for which the trader submitted an order;
determining, by the processor, whether an imbalance identified in the individual order book changed after fulfillment of the order; and
identifying, by the processor, the order as potential abusive behavior if the individual order book comprises an imbalance that changed after fulfillment of the order.

2. The computer-implemented method of claim 1 wherein the order comprises a bid, an offer, or a combination thereof.

3. The computer-implemented method of claim 1 further comprising receiving, by the processor, the order for the financial instrument from the trader.

4. The computer-implemented method of claim 1 further comprising receiving, by the processor, a counter order for the financial instrument from the trader, wherein the counter order lies on a side of a trade that is opposite to the order.

5. The computer-implemented method of claim 1 further comprising determining, by the processor, whether an imbalance identified in the trader's individual order book lies on a side of a trade that is opposite to that of the order.

6. The computer-implemented method of claim 1 wherein a change in the imbalance after fulfillment of the order comprises a partial cancellation of a resting order, a complete cancellation of a resting order, a modification of a resting order that moves the resting order away from a top of a full order book associated with the electronic market, or combinations thereof.

7. The computer-implemented method of claim 6 wherein the modification comprises a change in price, a change in quantity, or a combination thereof.

8. The computer-implemented method of claim 1 wherein the order appears as a top 10 entry in a full order book associated with the electronic market.

9. The computer-implemented method of claim 1 wherein the order appears as a top 5 entry in a full order book associated with the electronic market.

10. The computer-implemented method of claim 1 wherein the order appears as a “top-of-the-book” entry in a full order book associated with the electronic market.

11. The computer-implemented method of claim 1 wherein the potential abusive behavior is identified retroactively based on historical trading data stored in a database.

12. The computer-implemented method of claim 1 wherein the potential abusive behavior is identified in real time based on substantially contemporaneous trading data.

13. The computer-implemented method of claim 1 wherein the potential abusive behavior is selected from the group consisting of spoofing, flipping, layering, flickering, latency periods, and combinations thereof.

14. The computer-implemented method of claim 1 wherein the imbalance comprises a buy order on one side of a trade and a sell order on an opposite side of the trade.

15. The computer-implemented method of claim 1 wherein the imbalance comprises a buy order on one side of a trade and a sell order on an opposite side of the trade, wherein the buy order is larger than the sell order.

16. The computer-implemented method of claim 1 further comprising attaching, by the processor, metadata to each incoming message received from the trader, wherein the trader is uniquely identifiable from the metadata.

17. The computer-implemented method of claim 1 further comprising recreating, by the processor, a state of the individual order book associated with the trader and/or a state of a full order book associated with the electronic market.

18. The computer-implemented method of claim 17 wherein the recreating is based on metadata attached to each incoming message received from the trader.

19. The computer-implemented method of claim 18 further comprising filtering, by the processor, the full order book and/or the individual order book based on the metadata.

20. The computer-implemented method of claim 1 further comprising tracking, by the processor, a metric selected from the group consisting of book level, order duration, magnitude of change in order quantity, magnitude of change in order price, and combinations thereof.

21. A computer-implemented method for recreating a state of an order book for a financial instrument, the method comprising:
attaching, by a processor, exchange-generated metadata to each incoming message received from a trader, wherein the metadata uniquely identifies the trader;
tracking, by the processor, a metric selected from the group consisting of book level, order duration, magnitude of change in order quantity, magnitude of change in order price, and combinations thereof, wherein the tracking is based on the exchange-generated metadata and wherein the tracking occurs in real time using substantially contemporaneous data; and
storing, by the processor, data relating to the tracked metric in a database.

22. The computer-implemented method of claim 21 wherein the incoming message is selected from the group consisting of a new order for the financial instrument, a modification to an order for the financial instrument, a cancellation of an order for the financial instrument, and combinations thereof.

23. A system for identifying potential abusive behavior in an electronic market, the system comprising:
a processor coupled to a non-transitory memory, wherein the processor is operative to execute computer program instructions to cause the processor to:
(a) determine whether an individual order book associated with a trader comprises an imbalance in relation to a financial instrument for which the trader submitted an order;
(b) determine whether an imbalance identified in the individual order book changed after fulfillment of the order; and
(c) identify the order as potential abusive behavior if the individual order book comprises an imbalance that changed after fulfillment of the order.

24. A system for identifying potential abusive behavior in an electronic market, the system comprising:
a processor;
a non-transitory memory coupled with the processor;
first logic stored in the non-transitory memory and executable by the processor to cause the processor to determine whether an individual order book associated with a trader comprises an imbalance in relation to a financial instrument for which the trader submitted an order;
second logic stored in the non-transitory memory and executable by the processor to cause the processor to determine whether an imbalance identified in the individual order book has changed after fulfillment of the order; and
third logic stored in the non-transitory memory and executable by the processor to cause the processor to identify the order as potential abusive behavior if the individual order book comprises an imbalance that changed after fulfillment of the order.

25. The system of claim 24 further comprising fourth logic stored in the non-transitory memory and executable by the processor to cause the processor to receive the order for the financial instrument from the trader.

26. The system of claim 24 further comprising fifth logic stored in the non-transitory memory and executable by the processor to cause the processor to receive a counter order for the financial instrument from the trader, wherein the counter order lies on a side of a trade that is opposite to the order.

27. The system of claim 24 further comprising sixth logic stored in the non-transitory memory and executable by the processor to cause the processor to determine whether an imbalance identified in the trader's individual order book lies on a side of a trade that is opposite to that of the order.

28. The system of claim 24 further comprising seventh logic stored in the non-transitory memory and executable by the processor to cause the processor to attach metadata to each incoming message received from the trader, wherein the trader is uniquely identifiable from the metadata.

29. The system of claim 24 further comprising eighth logic stored in the non-transitory memory and executable by the processor to cause the processor to recreate a state of the individual order book associated with the trader and/or a state of a full order book associated with the electronic market.

30. The system of claim 24 further comprising ninth logic stored in the non-transitory memory and executable by the processor to cause the processor to filter the full order book and/or the individual order book based on the metadata.

31. The system of claim 24 further comprising tenth logic stored in the non-transitory memory and executable by the processor to cause the processor to track a metric selected from the group consisting of book level, order duration, magnitude of change in order quantity, magnitude of change in order price, and combinations thereof.

32. A system for identifying potential abusive behavior in an electronic market, the system comprising:
means for determining whether an individual order book associated with a trader comprises an imbalance in relation to a financial instrument for which the trader submitted an order;
means for determining whether an imbalance identified in the individual order book changed after fulfillment of the order; and
means for identifying the order as potential abusive behavior if the individual order book comprises an imbalance that changed after fulfillment of the order.

33. In a non-transitory computer-readable storage medium having stored therein data representing instructions executable by a programmed processor for identifying potential abusive behavior in an electronic market, the storage medium comprising instructions for:
determining, by a processor, whether an individual order book associated with a trader comprises an imbalance in relation to a financial instrument for which the trader submitted an order;
determining, by the processor, whether an imbalance identified in the individual order book changed after fulfillment of the order; and
identifying, by the processor, the order as potential abusive behavior if the individual order book comprises an imbalance that changed after fulfillment of the order.
